(19) United States
(12) Patent Application Publication
(10) Pub. No.: US 2010/0169111 A1
(43) Pub. Date: Jul. 1, 2010

(54) Portable Health & Safety Monitoring Device

(76) Inventors: Vesta Dauber Brue, San Antonio, TX (US); Jerome A. Hahn, Santa Barbara, CA (US)

Correspondence Address: Eugenia S. Hansen;Hemingway & Hansen, LLP, Comerica Bank Tower Suite # 2500, 1717 Main Street, Dallas, TX, 75201, US

(21) Appl. No.: 12/520,729

(22) PCT Filed: Dec. 21, 2007
(86) PCT No.: PCT/US07/26180

§ 371 Date: Oct. 28, 2009

Related U.S. Application Data
(60) Provisional application No. 60/876,685, filed on Dec. 22, 2006.

(51) Int. Cl. G06Q 50/00; G01S 19/13; G08B 13/00

(52) U.S. Cl. 705/2; 342/357.09; 340/541

(57) ABSTRACT

A portable health and safety monitoring device integrates real-time usage monitoring and wireless reporting. Wireless communications occur with each opening of a medication compartment which reporting the event time to a host server. The event is displayed online on a website accessible by authorized caregivers. The device optionally contains a global positioning system. In addition, the device optionally but preferably includes a panic button. Actions that are to occur upon actuation of the panic button can be stipulated by authorized caregivers, such as auto-dialing a physician or caregiver when a panic button press occurs. The device beeps when meds are due and immediately reports to the server after a lid opening.

### FIELD OF THE INVENTION

This invention relates in general to the field of electronic devices which monitor medication compliance and health and safety parameters.

### BACKGROUND OF THE INVENTION

There are many individuals who have chronic health conditions which need to be closely monitored by the individual, their caretaker and/or their treating physician.

For example, more than 13 million children and numerous adults, in particular senior citizens, are afflicted with chronic and often life-threatening diseases. Non-compliance with a treatment regimen can lead to serious consequences, such as the need to be admitted to a hospital on an emergency basis and/or long periods in intensive care. Further, even if such high level medical treatment becomes necessary, records as to the actual level of compliance with the prescribed treatment regimen may lead a treating physician to base further treatments on incomplete or erroneous information. Medication noncompliance is problematic at all ages. It is estimated that close to half of all 3.3 billion prescriptions dispensed annually in North America are incorrectly consumed and the pharmaceuticals' potential benefits are thereby mitigated and/or harm comes to the users. In med-taking, a rule of three is often cited, stating that ⅓ of patients takes all their medicine, ⅓ takes some, and ⅓ take none at all. (Haynes, 1989). A mean adherence rate of 76% among patients with physical disorders when measured by a microelectronic monitor was documented in a review of 12 studies of medication compliance (Cramer and Rosenheck, 1998).

An estimated 70% of missed doses are intentional (Cooper, Love, Rafoul, 1982). Side effects are a common reason given for intentional noncompliance, estimated at 17%. (Salzman, 1995). At least half of intentional skippers revealed in interviews that they felt they did not need the meds (Smith, 1989.). Overuse occurs when patients purposefully wish to raise the treatment effect, or when they forget they already took the dose. Of the reasons for unintentional medicine non-compliance, simple forgetfulness is the most frequently reported cause among all ages. (Aziz & Ibrahim, 1999; Ostrop & Gill, 2000). The information provided to the physician may be subject to even greater inaccuracy if the patient is a child, an elder suffering from memory loss, or even a busy adult who does not take the time to make accurate records. Inaccurate or incomplete information may cause a physician to reluctantly prescribe a higher dosage or a different medication with more side effects in order to obtain the desired therapeutic effect. This is particularly unfortunate if the current medication and dosage would have worked if the patient had been compliant, and the physician could have instead counseled the patient or his or her caregivers on compliance.

Several support tools have been proposed to assist patients with managing their chronic illnesses. One low-tech support tool is the medication organizer. These containers, usually made of inexpensive plastic, have multiple compartments to hold medications to be taken on different days of the week or at different times of day, and are relatively inexpensive. However, because they lack a reminding functionality (other than a static printed or stamped indicia on the compartment) they do not provide signals to the user which can aid in compliance. Medication organizers that do provide signals to the user such as alarm functions to remind the user when to take medications are better than the mere organizer, but do not gather data on actual compliance which is needed for accurate patient management and cannot change their instructions to the patient based on patient compliance or non-compliance with the regimen as a whole.

A medical compliance device by Vesta. L. Brue, inventor, was disclosed in U.S. Ser. No. 10/545,382, filed on Aug. 12, 2005 which will issue as U.S. Pat. No. 7,158,011 on Jan. 2, 2007 that provides certain advantages including the gathering of data on medication compliance, two-way communication, and relative time signaling. This patent application is herein incorporated by reference as if fully set forth herein.

Despite advances such as taught in U.S. Ser. No. 10/545,382, a need remained for a highly portable device that could be more effectively used by ambulatory persons that have chronic illnesses so that medications can be easily transported and accessible to the patient at all times, and so that health and safety events can be monitored as they occur in the patient's daily routines.

### BRIEF DESCRIPTION OF THE DRAWINGS

FIG. 1 is a front view of a portable health and safety monitoring device in which the front of the electric component housing and LCD screen is visible.

FIG. 2 is a perspective view showing the electric component housing and a pouch attached to the back side thereof which defines a medication compartment. The pouch is in open position and an exemplary medication container is visible.

FIG. 3 is a flow chart illustrating the parts and operation of the device

### DETAILED DESCRIPTION OF THE INVENTION

An improved device is now being disclosed which is an effective portable health and safety monitoring device and which can form part of a system for collecting and analyzing patient information and providing feedback to the patient, authorized caregiver, family physician, and/or researcher studying the effects of medication regimens on a patient population. The device preferably has alarming, recording, communicating, locating, and distress signaling components. The device is a non-invasive, monitoring and/or locating system which embodies essential functional and design elements to transport a variety of medication forms, including pills, inhalers, glucose meters, and insulin syringes, and alert a user to take medications at appropriate times using audio, visual, verbal, and vibrating alerting functions. The device will emit a reminder, using one or more of these alerting functions when it is time for the user to take medication. For example, a pre-recorded voice message, may alert the user. The recording can be one supplied with the device or custom messages can be recorded, for example by a parent of a child/user.

The device can be provided with a means for storage of electronic information concerning the time of access to a medication compartment. This stored data can later be communicated to a remote computer for analysis by downloading information from the device to a website or by establishing communication with the remote computer over a phone or high-speed communication line.

Alternatively and preferably, the device communicates the access event immediately to a remote computer, phone, electronic personal data assistant, a hub or gateway device, and/or email address via a wireless communication means employed in the device. The device will be able to be programmed to send a signal to one or more of these devices if the medication pouch is not opened within a specified time. The device will also automatically send a signal to a database when the medication pouch is resealed, presumably after the medication is taken. The device will also preferably automatically send a signal to a database when manually commanded to do so through the press of a specially-designated button.

The remote computer can determine timing adherence and dosing compliance, and conduct two way communication of information to and from the device.

In a preferred embodiment, the device communicates with a remote computer which in turn provides reports accessible from multiple locations on the World Wide Web concerning compliance feedback and also conveys emergency messaging to caregivers or to an emergency response system. In a most preferred embodiment, the device contains global positioning system (GPS) technology so that the location of the patient/user can be tracked in case of emergency situations (e.g., epileptic seizure) using the GPS technology. GPS also provides a new level of accuracy for direct quantification of time-location activity patterns. The device with the GPS feature will derive that functionality from an implanted chip similar to what is known and used in cellular phone technology. An exemplary chip set is available from Motorola, is installed in the electronic components area and connected to the microprocessor enabling stored data to be uploaded to the server and actionable queries to be received. This invention incorporates technology to provide a portable device and system which provides for medication compliance and/or health and safety monitoring. Such technology as telemetry, signal processing, component miniaturization, and battery-life extension are employed to make the device highly portable and suitable as a wearable personal health monitor.

Wireless and radio frequency technology, such as “Bluetooth” (Bluetooth is an industrial specification for wireless personal area networks (PANs). Bluetooth provides a way to connect and exchange information between devices such as mobile phones, laptops, PCs, printers, digital cameras and video game consoles via a secure, globally unlicensed short-range radio frequency) and “ZigBee” (ZigBee is the name of a specification for a suite of high level communication protocols using small, low-power digital radios based on the IEEE 802.15.4 standard for wireless personal area networks (WPANs) is also preferably employed to provide increased utility and portability to the device, as well as the ability to receive and transmit data from other devices that may provide or store information on the user's health or medication compliance.

The device provides for all-day wearability/portability of medications for easy access. In a preferred embodiment, a pouch-like compartment is provided and is capable of housing diverse medication forms such as the type needed on an everyday/all-day basis. These are not limited to, but will include, pills, insulin in pre-filled syringes, glucometers, and asthma inhalers.

The device has elements that provide a reminder to the user to take medication if a regimen is appropriate. Accordingly, a programming means permitting the user or caregiver to set one or more alarms and/or to provide visual, auditory, or oral warnings is included.

In another aspect of the preferred embodiment, the device is in wireless communication with a computer which receives electronic communications from the device and converts it to data relevant to the patient's compliance. The device can also receive communication from the computer or from other devices.

The device comprises an electronic assembly, a housing for the electronic assembly, and a compartment adapted to contain medication.

The compartment preferably comprises a fabric forming a pouch unit. The pouch is able to adapt to different shapes of medications that might be stored within it and is more comfortable than a rigid compartment when worn against the body of a user. In most cases, the wearer will prefer to attach the device to a belt at his or her midsection. Preferably, a flexible spandex fabric is used to maximize the adaptability of the fabric to the medications and to provide a degree of durability as well. The pouch can be made in different sizes if it is necessary to contain larger medications or multiple items. There may be a need, for example, for a user to place multiple items in the pouch, such as a glucose monitor, insulin syringes, and pills.

The device preferably contains means for electronically recording access to the pouch contents which is triggered by sensors that detect when a latch to the compartment is opened. In the case of multiple items, the system can provide specific announcements or messages as to what item is to be used at a given time. This feature can be programmed when the device is activated.

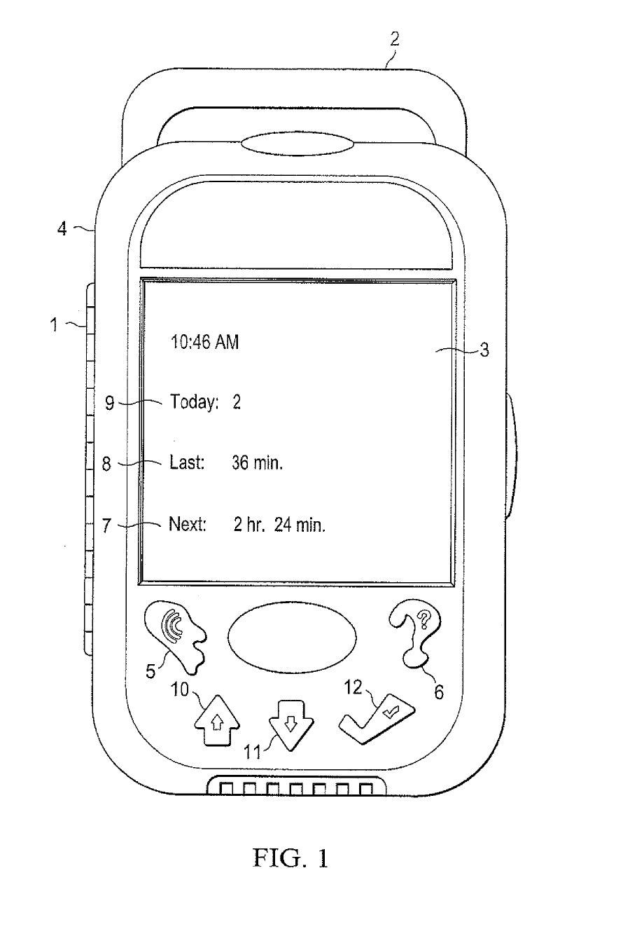

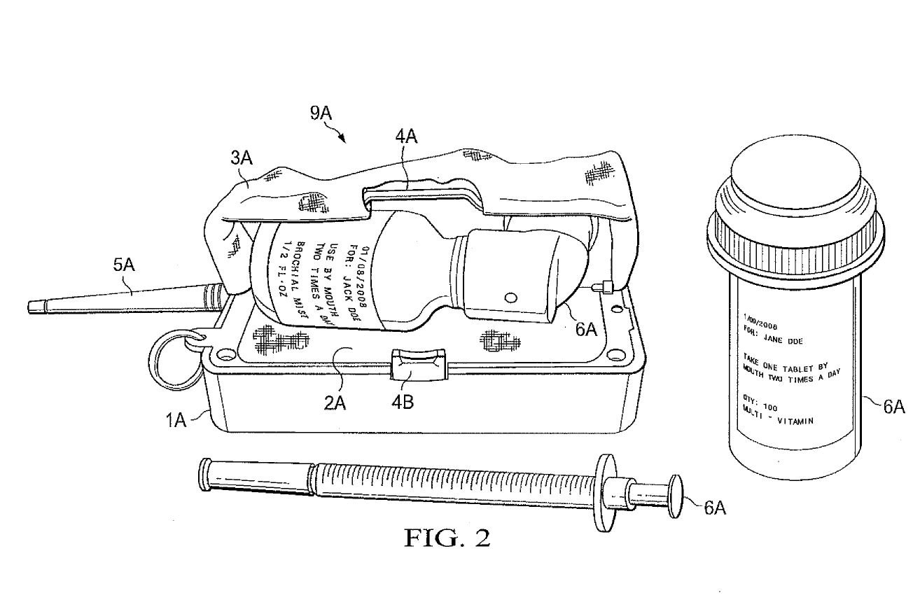

Now referring to FIG. 1, to ensure portability, the device (1) should be made as small as possible, taking into consideration the size of the medication that must be carried. An exemplary size is approximately palm-sized., measuring approximately 4″×2 to 2.5″×0.75″ when empty. It is preferred that the device be smaller and this is possible as the ability to make the electronic components smaller occurs through advances in miniaturization of component parts. To ensure portability, the device should be small enough to fit in a pocket or purse and/or to be worn by the user by attachment to a belt or clothing with an appropriate attachment means such as a carabiner. As best seen in FIG. 2, the device comprises electronic components in a housing (1A) and a compartment for medicines (2A) defined by the back wall of the electronic component housing and a flexible pouch material (3A). A support plate (not shown) can be installed on the back wall of the electronic housing to which the flexible pouch material can be attached, providing stability and protection to electronic parts. If employed, the support plate will preferably be made of metal or plastic. The support plate can be made wider than the back wall of the electronic component housing if it is desired to make the compartment dimensions larger to accommodate larger medication containers. An asthma inhaler is shown lying on the back wall of the electronic component housing. When rigid frame 4A is secured to latch component 4B, the medication is secured inside the compartment. The preferred Spandex-like fabric of the pouch serves the expansion needs of various mediation shapes and sizes, while collapsing when not filled. Overall when loaded, the depth of the pouch is up to about twice that of the electronic housing.

The device's housing is preferably made of a light-weight plastic material. Preferably, an acrylonitrile butadiene styrene (ABS) is employed. ABS is advantageous because it is a durable plastic used in football helmets and TV remote controls and is also FDA approved. In addition, it can provide high gloss and color attributes to the devices which make it aesthetically pleasing to the user.

The device requires an antenna for wireless communication, and it is desirable to conceal the antenna within the housing to assist in reducing the overall size of the device and to increase durability. In FIG. 1, an antenna is concealed in area (2), while a conventional antenna is shown in FIG. 2 at 5A.

It is also desirable that the device be durable and made of materials resistant to potentially destructive events or elements likely to be encountered by the user, such as dirt, sand, water, and dropping the device.

A liquid crystal display (LCD) is provided, best seen in FIG. 1 at (3). In a preferred embodiment, it measures about 1½″square and displays large type (14 pt) lettering with 20 characters on each of 4 lines, allowing label warnings to be expressed clearly.

Because ease of use is important, the device is provided with easy to use buttons which are easily actuated to provide frequently-used functions. It is not required but is desirable that the buttons provide visual or sensory indicia associate with their function. For example, sound volume is desirably controlled by a button shaped like an ear, shown in FIG. 1 (5). As another example, a question mark shaped button (FIG. 1 (6)) can be provided which will cause information to be displayed such as the time to next dose (e.g. NEXT: 11 hr 55 min (FIG. 7)), the time since the last compartment lid opening (in hours and minutes (FIG. 1,8), and the number of times since midnight that the lid was opened (FIG. 1 (9)). Repeated actuation of the button brings up different information. As yet another example, a Z-shaped button (not shown) may be provided as a snooze button. When actuated, the Z-shaped button will delay signaling by a predetermined period of time, such as 20 minutes or by a whole dosing cycle.

Audio, visual, vibrating and verbalized announcements can serve as signals to notify the user as to when it is time to take medication. As stated above, Visual information is displayed on a screen through a liquid crystal display (LCD), which preferably displays the units of medication to be taken. It is preferred that the device be provided with means to repeat this information through voice announcements. For power conservation, the LCD will “sleep” when not activated. A backlight will automatically illuminate the screen during lid openings.

An emergency or “panic” button is preferably provided and placed in an area which will minimize or eliminate false alarms. It is preferred that this button be located within the pouch compartment where it can be disguised, to avoid unintended actuation. Pressing of the panic button commands the device to wirelessly dial the server and upload currently stored data, such as its navigational position and any previously unreported data on lid openings of vital sign readings from related devices.

The electronics are placed in an upper section (FIG. 2, 1A) that is clasped to a lower section 2A comprising a rigid rim 4A made of metal or other suitable material and pouch material. The rigid rim provides structure to the soft spandex pouch. Sensors detect when the pouch clasp is opened, presumably to remove medications. The fabric pouch flexibly expands to accommodate various shapes, whether pill vials, inhalers, or glucose meters. (Examples shown in FIG. 2 at 7A)

Medication Programming: Preferably the device has means that provide ease of programming. It is preferred that a relative time dosing schedules be programmed or programmable into the device . . .

The dosing programming can be set at fixed times or on an interval basis. Once selected, this device derives alarm times (24, 12, 8, 6, 4, and 3 hours apart, etc.) based on the last pouch opening. Even if a medication is taken several hours late, the system resets the next dose alert at its correct interval, whereas a fixed-time based system would alert the next pill when scheduled, perhaps several hours prematurely. Even-interval pacing prevents long periods of low blood levels, reducing drug efficacy or times of overdose, and leading to side effects, which have been shown to increase noncompliance (Cinti, et al, 2000.)

The device is also preferably easily programmable. For example, after the fixed times of doses or the interval-based number of doses are set, the person programming the device will be asked a follow-up question via the LCD and/or voice announcement. The follow-up question will be medication related and, for example, will inquire as to the number of units (pills, puffs, eyedrops, etc.) to be taken at each dosing. Users (or caregivers, pharmacists, or assistants who are setting the device) will scroll (see scrolling buttons 10 and 11 in FIG. 1) through the choices, “Take 1 Unit” “Take 2” etc., and press the check mark button (FIG. 1, 12) when the unit matches their prescribed dosage, up to 9. Thereafter, when the compartment lid is opened, the patient is reminded how many units to take in at least one way, and preferably two or more ways: (1) a voice announcement states the number to take; (2) text will appear on the LCD screen, e.g. “Take 3.” (3) The LED light will rapidly flash corresponding to the number of units to be taken, and (4) an audio alert will beep the number of units to be taken.

The device can optionally be set up to receive additional programming, such as warnings associated with the drug, as shown on their prescription labels. In a preferred embodiment, nine possible warnings will be provided for selection, including “Take with Food,” “Take with Meals,” “Take with Water” and “May Cause Drowsiness.” Thereafter when the pouch is opened, the voice announcement audibly states the instruction and programmed warnings will flash on the LCD.

Users may easily adjust decibel level of audible alerts using the volume button. Continual pressing scrolls through three volume options: high, low, and mute, which are shown on the LCD screen.

Opening the compartment to take the drug or pressing a snooze button to delay will silence the audible alert. If beeps are muted but the pouch is not opened at signaling times, the LED will continue to flash until the lid is opened. Otherwise, if beeping is not silenced, all signals will continue intermittently until the lid is opened or the battery expires.

Power Management: Preferably, the device is powered by a rechargeable lithium battery. It is desired that one battery be sufficient so as to keep the weight of the device as low as possible. Low battery signals will be provided on the LCD before features begin shutting down. If battery warnings are ignored, features progressively begin shutting off (the last being the continuation of recording lid openings) until all power is lost. A battery recharging port is provided for a charger to be used to recharge the for the preferred power source which is a rechargeable battery. Alternatively, the device can be adapted to use disposable batteries in which case no recharging port need be provided.

Registering Emergency Specifications: The device or at least some of its potential functions will preferably be activated after registration by telephone helpdesk support or at a predetermined website provided to the customer. The serial number and the owner's contact information will allow for activation of the wireless telephone reception and tracking of the global positioning system. Further, a personalized website may be created for the patient. At registration, caregivers also specify the hierarchy for auto-notifications under emergencies, both by contact numbers and time parameters. They indicate the number of minutes/hours after a dosing alarm goes unanswered before the prescribed protocol is to be activated, generally by automated phone calls from our server. Preferably, a Graphic User Interface (GUI) is provided for ease in programming the desired information.

Wireless communications: The device preferably employs technology such as used in cell phones to provide automated emergency notification service. Information will be reported to the web to display location and to report pouch openings and panic button presses through small-batch data uploads using wireless communications and an on-demand communications service. Preferably, a cellular phone platform is used. Monthly service costs can be controlled by employing a platform built only on analog wireless communications, rather than the usual combined analog and digital service that is provided for most cell phones. However, this is subject to modification by the cost parameters provided by individual service providers.

Server Infrastructure: Each pouch opening triggers the chip to transmit the time-stamped usage data, linked to the serial number, to the server where it is filed by patient. Stored data are linked to an individual using HIPAA compliant encrypted associations with the serial number. These data will be stored in a database and compared to user-specified dosing intervals. Pouch opening times will be displayed on the user's personalized page in charts illustrating both adherence to total doses and timing compliance. Patients who are monitored for their compliance and are shown a graphical representation of their compliance level are more likely to adhere to a regimen than those who are monitored, but in which no record is shown to them (Hayes et al, 1979. In a preferred embodiment, the device will deliver the descriptions of specific actions associated with each event to assure that the correct item is removed from the device, for example by providing speech signals to the user.

The data transceiver in the device provides two-way communications, which includes both panic button notification, sending of global positioning coordinates, data received from other vital sign monitor signals, as well as pouch opening data. When a panic alarm is signaled, the device wirelessly and unobtrusively dials the server and communicates the distress, which sets in motion the prescribed emergency protocol. A similar alert will also be communicated in this way if the pouch is left open, indicating that the unit is not properly secured. While the LCD display itself is programmed to notify the user of this lid open fault, extended opening times must be communicated to third parties to intervene in its correction, as well as the server itself that might otherwise falsely report a proper condition.

Global Positioning System: The device equipped with GPS is always aware of its location, checking for changes in its coordinates on a frequent basis when the device is in motion. It stores that data in memory until the device is queried to upload coordinates or when any data upload occurs by phone connection. When a child and/or the device are late in reporting or the caregiver has other reasons, the caregiver can request a location report on the child. As currently designed, the caregiver opens the user's website personal page, accessed through password protection, and requests the device's positioning. This act will prompt a silent call to the device that reveals its current coordinates, as are refreshed immediately when requested. The data are translated into a street address range and mapped for viewing at the service's website or through a call center.

The GPS transmits signals from many satellites, and the GPS receiver needs only three valid coordinates in order to determine location of a device. In areas where a GPS signal is not available, the device is still able to communicate the last position recorded in memory. For example, when the device has entered a building, it may be unable to receive updated GPS information, but the location data prior to entering the building may be sufficient for determining the location of the user. The device will preferably provide automated GPS locating feedback to permit a remote caregiver to identify the current or latest reported location of the device.

Construction of the device begins with computer assisted mechanical drawings that are used to instruct the manufacturer in building tooling to the exact specifications and configuration of parts that are to comprise the housings. These tools enable a family of parts needed for the plastic housings to be injection moulded or cast in high-grade plastics to exact specifications. Simultaneously, on the assembly line, the electronic components, that are gathered from multiple sources, are joined together and fit into the plastic housings. Various installations of software and testing of electronic parts are performed, to assure the device performs as expected at each stage. When all quality assurance and testing is satisfied, the device is packaged into proper containers and shipped.

The device can be used as part of a system with preferably supportive software that links the device to a computer server, a GPS coordinates/locator server, and a web display. It is preferred that this incorporates a “server call-on-demand” functionality that will enable a caregiver to “wake up the device” from its sleep state with a command prompting the device to phone the server and send current coordinates. In order to limit a deluge of cell calls to the server unnecessarily, this approach calls for the device to report location information only when it is uploading or when it is asked to provide on-demand location.

A GPS host provider can be used in the system of the invention to provide cartography solutions and spatial/aerial photography. One current provider is Google Earth that offers automated linking capability that allows GPS data to be directly inserted into its reference location data. Google Earth does, optionally, display street names superimposed on the aerial photographs and is estimated for most residential areas to be accurate within 200 feet. It is a low cost service and would be useful in less populated areas where street addresses are inconsequential.

The system will include user specification of the rules-based hierarchy for the panic button alerting system. At any time that a user presses a panic button (to be preferably inside the medication pouch to avoid false activations), the device auto-dials the host server (via its cell phone technology) and identifies its serial number. This alert triggers the set of rules prescribed by the authorized caregiver to follow in such events, such as to first auto-dial a parent's cell phone to deliver its recorded alert, then the home phone, then send email alerts, etc. The capability of setting these rules will be built into the website with a GUI that is easy for the parent to set. For security purposes, on-demand activation of the panic button described below will not be reported on the device display but will be indicated with a light flashing on the device.

Now referring to the Flow Charts, FIG. 3 the microprocessor, together with the embedded firmware, provide the instructions necessary to operate the device. This includes the ability of the device to respond to commands, prompt the user to take action, and record information. For this device the microprocessor and memory store user defined settings, timed actions in memory and activates communications. Once settings are defined for events such as dosing times, medication warnings, and alert volumet, the device is ready for use. The microprocessor's basic action is to continuously compare the internal clock time to the next event time and, if it is equal to or greater than the time for the next event, it sends a user-selected alert that it is time to open the pouch. To accomplish this, the processor reads the memory to check what alert setting the user defined through the programming buttons. It then uses the alert setting found in the memory to do any of the following: Visual, Audible, or Vibratory alert. After the user responds to the alert and opens the medication compartment, the medication compartment will send a signal to the processor saying that the pouch was opened. The processor then checks the Real Time Clock and puts the event type and time into memory. A flag is then set in memory telling the processor to wait through a programmer-defined period of time to upload data to a remote server via the Wireless Communications Transceiver/GPS Locater. The processor then activates the transceiver and checks to see if it can connect to a network. If not, the processor will automatically try again later. If the transceiver connects to the network, it will automatically dial the Remote Server's number and connect. If the connection fails or a transfer fails, then the processor will set a flag in the memory to try again later. When it does connect, the processor will then activate the communication of the data to send including timed events as well as the GPS location.

The processor will take the last stored event and use it for calculations. After the Data is transferred and verified, the device will then delete all events except the last event in memory. If the schedule for the device is set by the user to Relative Time, the processor will then add the Relative time period to the last timed event to determine the next event time. This information may be displayed on the LCD when the user presses a defined button. This allows users to see the last time they took a pill and the next time they are scheduled to take one. This also ensures doses are not taken too early.

If the regimen events are set to Fixed Time, the device microprocessor simply compares the next scheduled fixed time event to the current time and waits till the time is >= to the time on the Real Time Clock oscillator. The user may view the LCD to determine the time since the previous event as well as the time until the next event. While the device is trying to connect to the remote server, the LCD will show the status of the process. This way, users can see if they failed to connect in any way or if the transfer completed.

The remote server will host a site for the user to be able to access at any location with Internet access. Users or authorized caregivers will be able to see the location of a device when an event occurred, as well as the time and type of event. Caregivers may also contact the device through the Remote server by dialing back to the device to receive GPS location and other information. Setting may also be reset through programming changes on the server that can be downloaded to the device.

The device also has a rechargeable battery with a Power Supply DC Converter plug. The voltage detector will allow the device to know when it's plugged in and starts recharging the battery. The device will continue to function with a low battery collecting data but may not be able to upload until the device is recharged.

FIG. 3. This flow chart shows the way the hardware components, communicates to one another.
1. Remote Server—Stores all event data and GPS locations allowing access to information through Internet access. Remote Server can also change settings on device and request information at any time.
2. Wireless Communications Transceiver/GPS Locater—Transmits and receives information through wireless communications. GPS Locater will send the location of the device.
3. Real Time Clock Oscillator—An internal oscillating crystal provides a constant frequency that is used to keep accurate time.
4. Voltage Detector—A switch to detect if a DC power source is connected.
5. Power Supply—Battery or DC power source giving a constant flow of electricity to the hardware components, which require power to function.
6. Wireless short-range network interface receiver—A component used for short-range communications. Wireless package is modular, accepts RF, Bluetooth or ZigBee communications.
7. Communicating biometric data collection devices—transmit data to the appropriate technology module with the device. Replaceable modules include a Bluetooth, Zigbee, and RF modules.
8. Memory—Storage of variables for calculations, settings for the device, and timed stamped history of events.
9. Microprocessor—Processes, executes, transfers commands to components, receives component information, and calculates information allowing the device to function and multiple hardware units to communicate with one another.
10. Programming Buttons—User interface that sends commands to the hardware allowing a User to change the settings on the device.
11. LCD Display—Hardware allowing a User to view information and options on the device.
12. Medication compartment sensor—Switch in a device that detects if the Medication compartment is open or closed.
13. Visual Alert—LED light which blinks to signal a user.
14. Audible Alert—Piezo speaker creates sound to signal a user.
15. Vibratory Alert—Hardware component that causes the device to vibrate to signal to a user.

The device disclosed herein is also effective as a method for managing pediatric chronic diseases. Chronic diseases that are subject to strict medical treatment requirements in children, adolescents and adults include asthma, diabetes, epilepsy, attention deficit hyperactivity disorder (ADHD), HIV infection, lupus, cystic fibrosis, idiopathic or rheumatoid arthritis, and organ post-transplant therapy, among others.

Asthma impacts an estimated at 6.2 million school-aged children. American Lung Association (2003). Asthma is much more prevalent among children than adults and is the leading cause of childhood illness that disproportionately affects minority children (Childhood Asthma Management Program, 2003). Asthma nationally kills 4,000 people a year, with the majority of asthma related deaths occurring among children (Guendelman, et al., 2002). The national costs for asthma care exceed $10 billion dollars a year and continue to place a heavy burden on patients, families, the healthcare system, and schools. Asthma is the leading cause of school absenteeism, with 14 million school days lost annually (ALA, 2003). According to a national sample of members surveyed from the National Association of School Nurses (2003), asthma is more disruptive of school routines than any other chronic condition, signaling the need for new and improved approaches to help alleviate this growing problem.

The need for emergency response provision for asthma sufferers is well recognized, as evidenced by references to their major drug category as “rescue” drugs. Therefore, many schools that otherwise prohibit students from carrying and administering their own medications do permit students to carry their inhalers. Because of the youthful age of these patients, it is difficult to obtain accurate data as to their medication needs.

A method for managing asthma can be practiced by use of the device of the invention. The device has a compartment that is adapted to carry asthma inhalers, peak flow meters, and/or other necessary medication and monitors. The device can collect data on patient compliance and usage of the medications or monitors, which can be used by the physician to better prescribe a treatment regimen. The GPS system and the panic button are helpful to managing the asthma patient and making sure they are able to obtain help in an emergency.

Insulin-dependent diabetes mellitus requires patients to monitor glucose levels and to have insulin readily available when the blood sugar levels exceed the pre-established level. Type II diabetes patients also need to monitor glucose levels and use medications. Again, the age of patients may prevent accurate monitoring of these levels and insulin use.

A method for managing diabetes can be practiced with the disclosed device. The pouch is capable of containing pre-loaded insulin syringes, oral medications, and small glucose monitors. The device can collect data on patient compliance and usage of the medications, which can be used by the physician to better prescribe a treatment regimen. The GPS system and the panic button are helpful to managing the diabetes patient and making sure they are able to obtain help in an emergency. Further, the wireless capability allows the device to communicate with separate devices with wireless capability, such as Bluetooth or ZigBee, to obtain data on blood sugar levels. All of these data are communicated to a server where they can be analyzed, charted, and viewed by the physician, patient, and or caregiver.

Care and management of diabetes is necessary to lower the potential for complications. Depending on the severity and type of diabetes, patients need to periodically monitor blood glucose levels and take appropriate actions such as intake of food, insulin therapy, or use of other prescribed medications. With increasing awareness and access to diabetes information, patients are becoming more self-reliant in their efforts to manage their conditions. Self-monitoring of blood glucose (SMBG) is an integral part of the management plan for people with diabetes. It allows diabetic patients to develop a profile that lets them make day-to-day decisions regarding their meals, physical activity, intake of oral agents and medications such as insulin.

In the care of diabetes, features such as biosensor technology, easy to load test strips, and strip capillary action have served to increase testing convenience and efficiency. Additionally, many of the improvements, for instance, the reduced testing times and sample sizes, continue to become standardized across various brands of glucose testing devices. These improvements are enhancing the market penetration of self-monitoring and in turn, the effectiveness of remote patient monitoring programs. The emergence of improved medications that allow diabetics to maintain glycemic control have been welcomed by patients. In the case of elderly patients who forget to take medication on time, remote patient monitoring programs assist them with friendly medication reminders that assist in the management of sound glycemic control. Getting all the information relevant to the state of the disease, such as blood glucose levels and medication compliance, will assist in the effectiveness of the treatment regimen.

Ensuring children take their medications is a well-documented problem. For example, NIH's National Diabetes Program states: “Every day, children with diabetes may need to take insulin or oral medication. For school-age children, these tasks can make them feel “different” from their classmates. These tasks can be particularly bothersome for teens.”

Epilepsy (recurrent unprovoked seizures) affects 2.3 million Americans, about 300,000 of them children under age 14. Epilepsy presents at different ages, and in different ways, for some it will be a lifelong challenge affecting many areas of life, including lower levels of self-efficacy, risk in operating motor vehicles, and safety concerns in being alone (Deloris, et al., 2003).

Improving seizure control is a high priority for caregivers. Severe seizures that resist treatment, especially those in early childhood, are associated with shortened life span, risk of intellectual impairment, and sharply reduced quality of life (Barnhurst, 2001). Many experts report that noncompliance is the number one problem among youth with epilepsy. It can be very difficult, even for the most disciplined adult, to take medication every day.

A method for managing epilepsy is provided by the device disclosed herein. As previously mentioned, the device preferably includes a “panic button” which allows a patient in distress, such as from a seizure, to call for help quickly via the Panic Button and, moreover, to be located via the global positioning system in the device. In addition, the device monitors medication usage and can communicate through wireless means and Bluetooth technology to other devices and computers.

Various approaches have been examined for improving or achieving medication adherence among HIV disease survivors. Pontali (2005) has argued that treatment of HIV infection with highly active antiretroviral therapy (HAART) requires sustained medication adherence of 95% or higher to maintain efficacy in patients. Cunningham et al. (2006) reported that adherence to antiretroviral medication regimens among HIV positive children is influenced by psychosocial factors that requires flexible and comprehensive treatment approaches.

A method for managing HIV-related illness is provided by the device disclosed herein. Caregivers or case managers can view a patient's historic HAART adherence rates and intervene to encourage greater compliance with protocols. Physicians examine adherence charts, if authorized, and note when the patient has exhausted their response to a previous class of drugs, suggesting a cause for resistance. As previously mentioned, the device preferably includes a “panic button” which allows a patient in distress to call for help quickly and moreover to be located via the global positioning system in the device. In addition, the device monitors medication usage and can communicate through wireless means and Bluetooth technology to other devices and computers.

ADHD is the most common form of neurobehavioral disorder in children, with the CDC estimating 4.4 million children reported to have a history of ADHD and 2.5 million children reported to be receiving pharmacotherapy. (Visser et al 2003). ADHD typically manifests as inattentive and/or hyperactive or impulse behavior. Evidence clearly suggests that adherence to stimulant medications is a significant factor in the long-term treatment of children with ADHD (Thiruchelvam, Charach & Schachar, 2001). Of particular consequence is the lack of adherence and, further, the lack of understanding of ADHD as a chronic condition. There is strong evidence, that as untreated or nonadherent ADHD adolescents approach adulthood, they have greater risk of accidents and a greater likelihood of behavior-caused social difficulties.

A method for managing ADHD is provided by the device disclosed herein. The interval-based signaling capability assures intake of ADHD medications are taken in smooth titration, reducing the side effects associated with peaks and valleys in dosing times.

Elderly patients often have a number of simultaneous ailments, but some may require immediate treatment. The device will allow such patients to have a supply of medication for emergency situations at the ready at all times. By having the device, the patient can go about a normal life but feel secure in the fact that life-saving treatment is at hand. The device can be used in a method for management of elder patients.

Researchers who do studies on drugs and treatment plans often cite problems with faulty studies due to problems with noncompliance. Studies show that between one third and one half of patients who are prescribed medication either do not take it or take it improperly. The device can be used in a method for doing research on the effects of drugs and treatment plans.

### EXAMPLE 1

A total of 54 devices were built and hand-assembled into urethane housings cast in molds made from stereolithography models. All could be set for either full functioning of the alerts and LCD feedback for the treatment condition of our randomized controlled trial, or alternatively for silencing of signals and feedback in the control condition. In this silent mode, liquid crystal displays (LCDs) were masked, rendering them usable only as event data collectors. All devices wirelessly auto-dialed the server within a minute after a lid opening to upload the event data. Immediately, the child's usage was posted to charts and displayed on individual web pages, accessed only with usernames and passwords. The charts could be viewed by concerned parents and caregivers who could remotely follow the child's use of meters, syringes, pills, inhalers, or other medication forms. The GPS uploaded coordinates with each call, and our investigators could identify a child's location on the Google Earth website.

Feasibility, usability, and efficacy were evaluated in a 23-day study period using a randomized controlled study. We compared subjects in two conditions: (1) using the fully functioning device with med-time alerts, instant wireless communications, and uploads to servers, and (2) using masked devices that incorporated only the time-stamping of lid openings, providing comparable monitoring to the experimental condition without rendering any treatment. Outcome variables included measures of timely medication compliance plus measures of usability and satisfaction.

Recruitment. A total of 85 children ranging from 6 to 17 years of age and diagnosed with chronic disease were recruited through flyer distribution in local physician groups or community-based clinics.

The study combined structured interviews and questionnaires of both children and their parents to evaluate the efficacy and usability of the device. Participants and their caregivers were screened during a brief phone interview assessing their fit with inclusion and exclusion study criteria and discussion of the randomized study format. Once they appeared to qualify, study coordinators met with the child and parents at their own homes for subsequent meetings where they signed Institutional Review Board-approved Informed Consent and Assent documents, completed intake assessments, were randomized, issued either control (masked and deactivated) devices or active units (with full functioning feedback), and demonstrated capability of handling the technology. From the home the coordinator confirmed that each device was sending cell phone signals to the server. Each child's medication regimen was entered in the device by the family and coordinator, and hardcopy notes were taken to assure database files would match the child's scheduled dosings, such that charts could show discrepancies between actual and scheduled intake.

For 23 days, all devices wirelessly dialed servers immediately after lid openings and transmitted data. Half of the devices alerted kids at scheduled dosing times, using audible beeps, flashing light-emitting diodes (LEDs), and text on the screen. Upon pressing a button, the times since the last pouch opening was displayed, along with time until the next meds were to be taken. The half of participants in the control condition received no signals at meds-time, and their LCDs were masked. Yet, their devices did quietly call the servers and send data immediately. Only one participant was enrolled who lived beyond the cell phone reception range and whose uploads required special handling. After a relatively short shake-out period, all other devices performed flawlessly. On Day 23, the study coordinator revisited the home, conducted exit questionnaires and interviews, and collected devices.

Attrition and Missing Data: Participants were instructed that they could withdraw from the study at any time. Of the 90 enrolled in the study, 5 devices malfunctioned at the early stages and did not upload adequate data to be usable in analysis. Thus, 85 participants (94% of enrollees) completed the study.

Patient assessments of system usability: Evaluation methods included both qualitative and quantitative measures of product feasibility. Analysis was based on an 11-item usability questionnaire with a 5-point Likert Scale and free response to open-ended questions. All 85 participants responded to the usability questionnaire. The questions were stated in first person, age appropriately, and have been abbreviated here to reflect the generalized topic.

Overall, they rated the device with an average score of 3.71 out of 5.0, with 5 representing “Strongly Agree” and 1 representing “Strongly Disagree.” Surprisingly, the means for the active and control groups were very close to the overall mean −3.72 and 3.70 respectively.

Efficacy. The Control group had 24% lower adherence within the acceptable timing window than did those in the Active condition. Timing compliance was regarded as acceptable if was within 15% of the interval length between dosings. The primary outcome of medication compliance was examined. Compliance measures were calculated for each individual based upon the number of lid openings that occurred within the 15% window (e.g., ±3.6 hours for every 24 hour dosing, ±1.8 hours for every 12 hour dosing). Repeated lid openings that occurred within 1 hour of the target were ignored. Independent group's t-test was used to examine differences in compliance between the active and control groups.

The results showed a clear benefit for active signaling over the control condition. Overall, mean timing compliance in the active group was 70.8% compared to 46.5% in the control condition (t (75)=4.28, p<0.0001). The overall result was largely mirrored for once a day dosing: 69.1% vs. 39.2% (t (60)=4.28, p<0.0001); with twice daily dosing regimens compliance was 47.7% and 16.7% for active and control respectively (t (28)=3.64, p<0.002). There were no significant relationships of medication compliance with age of patient or family income, either main effect or interaction with experimental condition.

We claim:

1. A portable health and safety monitoring device comprising electronics components, a housing for said electronics components having a front side and a back side, a compartment for holding medications defined by said back side and a flexible pouch material attached to one side thereof, a rigid frame secured to the pouch material, and a latch on said back side further comprising sensors, whereby said sensors activate an electronic signal when said rigid frame is secured to said latch indicating that the medication compartment has been accessed by a user.

2. The device of claim 1, further comprising real-time usage monitoring means and a wireless reporting means.

3. The device of claim 2, wherein said wireless reporting means sends a signal to a host server with each opening of said compartment which holds the user's medication and reports the event time.

4. The device of any of claims 1-3, wherein the device further comprises a global positioning system.

5. The device of any of claims 1-3, wherein the device further comprises a panic button.

6. The device of claim 4, wherein the device further comprises a panic button.

7. A system for medical monitoring, wherein information concerning a user's medical and safety status and compliance with treatment protocols is sent by the portable device of claims 1-3 to a host server which in turn converts the information into a perceivable event displayed online on a website accessible by authorized caregivers.

8. The system of claim 4, wherein a user's compliance can be monitored on the World Wide Web from any location.

9. The system of claim 6, wherein said host server can communicate instructions or information to said device.

10. A method for the management of chronic disease, comprising employing the device of claims 1-6.
